(19) United States
(12) Patent Application Publication
(10) Pub. No.: US 2008/0009204 A1
(43) Pub. Date: Jan. 10, 2008

(54) Conducting terminal connector and method of fabricating the same

(76) Inventor: Yang Chun Wei, Chang Hwa (TW)

Correspondence Address: REED SMITH LLP, Suite 1400, 3110 Fairview Park Drive, Falls Church, VA, 22042, US

(21) Appl. No.: 11/878,395

(22) Filed: Jul. 24, 2007

Related U.S. Application Data
(63) Continuation-in-part of application No. 11/522,470, filed on Sep. 18, 2006.

(30) Foreign Application Priority Data
Jul. 5, 2006 (TW) 095124557
Feb. 1, 2007 (TW) 096103656

(51) Int. Cl. H01R 4/10

(52) U.S. Cl. 439/877; 29/874

(57) ABSTRACT

This invention relates to a terminal connector and method of fabricating the same. The terminal connector is comprised of a conducting terminal, an insulating tube and a soldering sleeve, for joining the conducting terminal and a conducting wire. The conducting wire includes a conducting core and an insulating cladding enclosing the conducting core. The insulation tube with a melting point at a second temperature is shrunken and deformed when heated to a temperature higher than a first temperature. The conducting terminal has a first end accommodated in the insulation tube and an exposed opposite second end for connecting to an external conducting contact point. The first end is bent to form a longitudinal elongation with an opening facing upward. The soldering sleeve with a corrugated surface is placed on the longitudinal elongation of the conducting terminal. The soldering sleeve has a melting point at the third temperature, which is between the first and the second temperatures. The soldering sleeve allows for insertion of a conducting core with the insulating cladding stripped off.

### RELATED APPLICATION

This application is a continuation-in-part of U.S. patent application Ser. No. 11/522,470 filed Sep. 18, 2006. Priority is claimed based on U.S. patent application Ser. No. 11/522,470 filed Sep. 18, 2006, which claims the priority of Republic of China Application Nos. 095124557 and 096103656 filed on Jul. 5, 2006 and Feb. 1, 2007, respectively, the entire text of which is hereby incorporated by reference.

### BACKGROUND OF THE INVENTION

1. Field of the Invention

The present invention relates to a conducting terminal connector and a method of fabricating the same, and more particularly, to a conducting terminal connector that employs an insulating tube and a soldering sleeve as a joining device for joining a conducting terminal and a conducting wire.

2. Description of the Related Art

In a conventional method of joining two conducting wires, an insulating adhesive tape is used to wind around conducting cores of the conducting wires that are exposed outwardly of insulating claddings of the conducting wires, in order to cause the conducting cores to connect with each other, thereby achieving electrical conduction therebetween. However, due to the use of adhesive tape, the conducting wires may be easily affected by environmental factors, which cause electric leakage or problems related to dampness. In response to these problems, U.S. Pat. No. 4,883,925 proposed a conducting wire connecting device 100. Referring to FIG. 1A, the connecting device 100 includes an insulating tube 102 with an adhesive coating 106 on an inner surface thereof. A solder sleeve 104 with smooth outer and inner surfaces is disposed in the insulating tube 102. The outer surface of the solder sleeve 104 is connected to the inner surface of the insulating tube 102 by the adhesive coating 106. An external heater is then used to melt the solder sleeve 104 in order to join the conducting cores of the two conducting wires. The insulating tube 102 is then heated and shrunken to fix the conducting wires, thereby achieving the connection of the conducting wire and electrical conduction. However, forming the adhesive coating 106 on the inner surface of the insulating tube 102 of the connecting device 100 leads to high production cost, and it can be difficult to dispose the solder sleeve 104 into the insulating tube 102 after the formation of the adhesive coating 106.

Referring to FIG. 1B, U.S. Pat. No. 5,137,478 proposed a conducting terminal connector with solder material. The conducting terminal includes a semicircular end portion 108. A solder material 110 is coated on an inside of the semicircular end portion 108 for connecting with a conducting core.

Referring to FIG. 1C, U.S. Pat. No. 6,666,732 proposed another conducting terminal connector with solder material. The conducting terminal includes a round tubular end portion 112. The round tubular end portion 112 includes a solder sleeve 114 for connecting with a conducting core.

The above-mentioned prior art technologies still have some disadvantages in practice and thus need to be improved.

### SUMMARY OF THE INVENTION

To address the problems in the prior art, the present invention provides a conducting terminal connector and a method for fabricating the same. The conducting terminal connector is comprised of a conducting terminal, an insulating tube and a soldering sleeve, for joining the conducting terminal and a conducing wire. The conducting wire includes a conducting core and an insulating cladding enclosing the conducting core. The insulating tube is shrunken and deformed when heated to a temperature higher than a first temperature, and has a melting point at a second temperature. The conducting terminal includes a first end accommodated in the insulating tube, and a second end opposite to the first end and exposed outwardly for connecting to an external conducting contact point. The first end is bent to form a longitudinal elongation with an opening facing upward. The soldering sleeve is placed on the longitudinal elongation of the conducing terminal, and has a melting point at a third temperature between the first temperature and the second temperature. The soldering sleeve has an outer periphery with a corrugated surface formed thereon. The soldering sleeve allows for insertion of a conducting core with the insulating cladding stripped off.

When a heat source is applied to an outer part of the insulating tube that corresponds to the soldering sleeve to heat the insulating tube to a temperature between the first temperature and the third temperature, an inner part of the insulating tube that corresponds to the soldering sleeve shrinks to lodge into corrugation gaps of the soldering sleeve, thereby fixedly joining the insulating tube and the soldering sleeve to form the conducting terminal connector. In joining the connecting terminal and the conducting wire, the conducting core of the conducting wire that is exposed outwardly of the insulating cladding is inserted into the conducting terminal connector, and an external heat source is used to heat the soldering sleeve to the third temperature to make the soldering sleeve melt, thereby joining the conducting terminal and the conducting core. The insulating tube is then heated and shrunken to fix the conducting wire, thereby successfully fixing the conducting wire and achieving electrical conduction between the conducting core and the conducting terminal.

Accordingly, a main object of the present invention is to provide a conducting terminal connector that has a good connection between the soldering sleeve and the insulating tube.

Another object of the present invention is to provide a conducting terminal connector in which the soldering sleeve and the insulating tube are easy to assemble.

Another object of the present invention is to provide a conducting terminal connector in which the soldering sleeve and the conducting wire are easy to assemble.

Another object of the present invention is to provide a conducting terminal connector in which the soldering sleeve and the insulating tube consolidate to form a conducting structure with good structure strength.

Another object of the present invention is to provide a method for fabricating a conducting terminal connector that has a good connection between the soldering sleeve and the insulating tube.

Another object of the present invention is to provide a method for fabricating a conducting terminal connector, which allows the soldering sleeve and the insulating tube to be assembled easily.

Another object of the present invention is to provide a method for fabricating a conducting terminal connector, which allows the soldering sleeve and the conducting wire to be assembled easily.

Another object of the present invention is to provide a method for fabricating a conducting terminal connector in which the soldering sleeve and the insulating tube consolidate to form a conducting structure with good structure strength.

### BRIEF DESCRIPTION OF THE DRAWINGS

FIG. 1A through FIG. 1C show conventional conducting terminal connectors;

FIG. 2 is a schematic view of a conducting terminal connector in accordance with the present invention;

FIG. 3A through FIG. 3E show schematic views of preferred embodiments of the soldering sleeve in accordance with the present invention;

FIG. 4A through 4L show schematic views of preferred embodiments of the conducting terminal in accordance with the present invention;

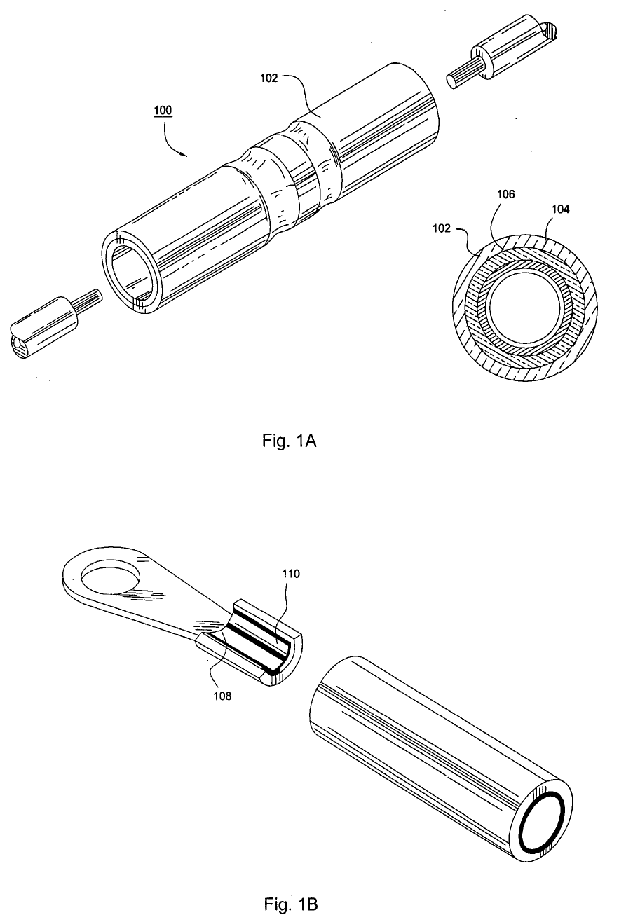

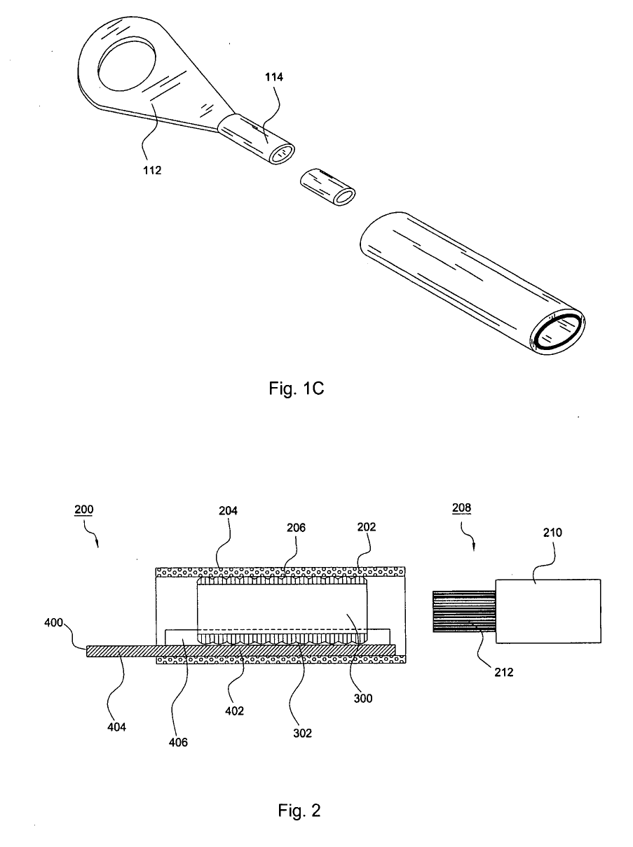

### DETAILED DESCRIPTION OF THE EMBODIMENTS

The present invention discloses a structure of a conducting terminal connector and a method for fabricating the same. The principle in the connector fabrication and electrical conduction has been disclosed in details in the related art section; therefore, the manner that the conducting wire is connected to the conducting core will not be described in further details in the following description. Also, the drawings referred to in the following description are not made according to actual dimensions and are merely schematic views showing features of the present invention.

FIG. 2 is a schematic view of a conducting terminal connector in accordance with the present invention. The conducting terminal connector 200 is comprised of an insulating tube 202 and a soldering sleeve 300, for joining a conducting terminal 400 and a conducting wire 208. The insulating tube 202 is shrunken and deformed due to its own material characteristic when heated to a temperature higher than a first temperature and has a melting point at a second temperature. The conducting terminal 400 includes a first end 402 accommodated in the insulating tube 202, and a second end 404 opposite to the first end 402. The second end 404 is less than the insulating tube 202 in length and is exposed outwardly, for connecting to an external conducting contact point. The first end 402 is bent to form a longitudinal elongation 406 with an opening facing upward. The longitudinal elongation 406 is semicircular or C-shaped for placement of the soldering sleeve 300. In addition, the material of the conducting terminal 400 may be selected from the group consisting of brass, bronze, copper alloy, stainless steel, gold, karat gold alloy and platinum. The conducting wire 208 includes a conducting core 212, and an insulating cladding 210 enclosing the conducting core 212. The soldering sleeve 300, which is a hollow structure with a corrugated surface and allows for insertion of the conducting core 212 with the insulating cladding 210 stripped off, is firstly disposed on the longitudinal elongation 406 of the conducting terminal 400, and the conducting terminal 400 together with the soldering sleeve 300 are disposed on the longitudinal elongation 406 and then disposed in the insulating tube 202. The soldering sleeve 300 has a melting point at a third temperature between the first temperature and the second temperature. Whatever shapes the soldering sleeve 300 can be made into, its material can be selected from the group consisting of tin, lead, nickel, gold, silver, copper, bismuth and alloys of any of the above metals. The corrugated surface 308 of the soldering sleeve 304 can be wave-like or serrate, wherein the height of the waves can be identical or different, and the distance between the waves can also be the identical or different; the height of the serrations can be identical or different and the distance between the serrations can be identical or different.

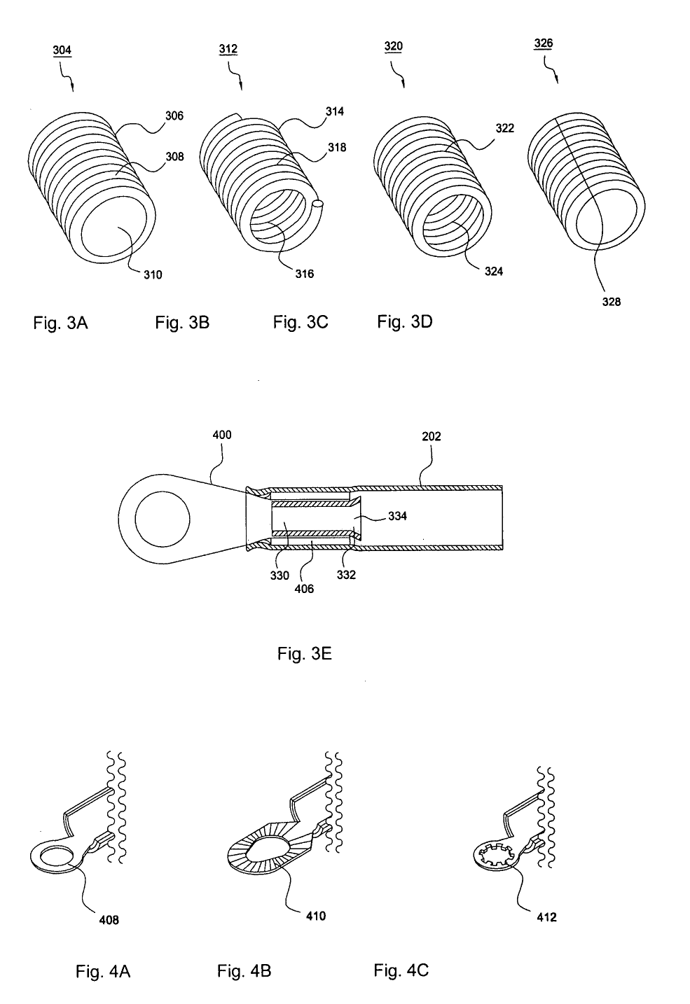

FIG. 3A shows a preferred embodiment of the soldering sleeve 300. The soldering sleeve 304 has an outer periphery 306 with a corrugated surface 308 formed thereon, and an inner periphery with a smooth surface 310 formed thereon, allowing for insertion of the conducting core 212 with the insulating cladding 210 stripped off. When a heat source is applied to an outer part 204 of the insulating tube 202 that corresponds to the soldering sleeve 304 to heat the insulating tube 202 to a temperature between the first temperature and the third temperature, an inner part 206 of the insulating tube 202 that corresponds to the soldering sleeve 304 shrinks to lodge into corrugation gaps 302 of the soldering sleeve 304, thereby fixedly joining the insulating tube 202 and the soldering sleeve 304 to form the conducting terminal connector 200, thus achieving a more reliable connection between the soldering sleeve 304 and the insulating tube 202, so that they cannot be disconnected easily . In joining the connecting terminal 400 and the conducting wire 208, the conducting core 212 with the insulating cladding 210 stripped off is inserted into the conducting terminal connector 200, and a heat source is applied in order to heat the soldering sleeve 304 to the melting point of the third temperature. Therefore, the soldering sleeve 304 in the conducting terminal connector 200 melts and consolidates with the conducting core 212 to form a conducting structure with good structure strength.

FIG. 3B shows another preferred embodiment of the soldering sleeve 300. The soldering sleeve 312 is formed by winding a solder wire so that both of its outer periphery 314 and inner periphery 316 have a corrugated surface 318. Since the measure of area of corrugated surface is increased, the soldering sleeve 312 and the insulating tube 202, or the soldering sleeve 312 and the conducting core 212 consolidate to form a conducting structure with better structure strength.

FIG. 3C shows another preferred embodiment of the soldering sleeve 300. The soldering sleeve 320 includes an outer corrugated surface 322 and an inner corrugated surface 324. The measure of area of corrugated surface is also increased, the soldering sleeve 320 and the insulating tube 202, or the soldering sleeve 320 and the conducting core 212 consolidate to form a conducting structure with better structure strength.

FIG. 3D shows still another preferred embodiment of the soldering sleeve. The soldering sleeve 326 has an apparent gap 328 therein, which is a characteristic formed in the process of metal forming.

FIG. 3E shows still another preferred embodiment of the soldering sleeve 300. The soldering sleeve 330 further comprises an extension 332 over the longitudinal elongation 406 of the conducting terminal 400. The extension 332 is provided with a radial enlargement 333 for better insertion of the conducting core 212.

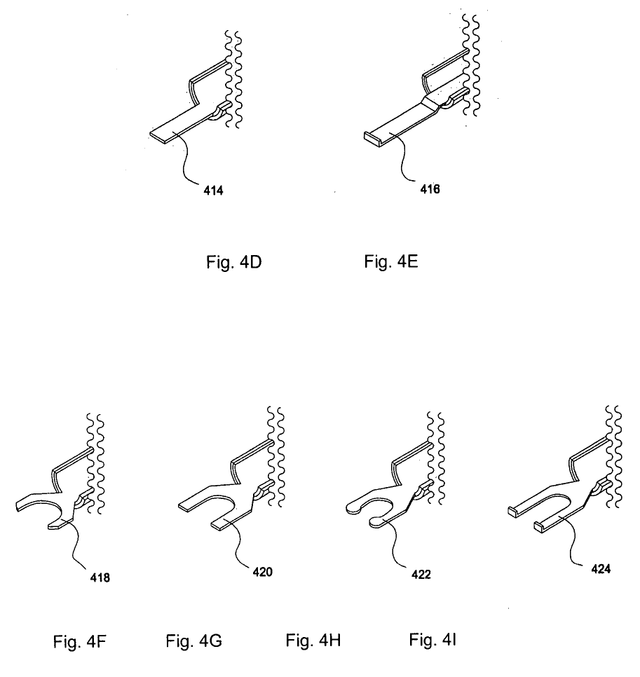

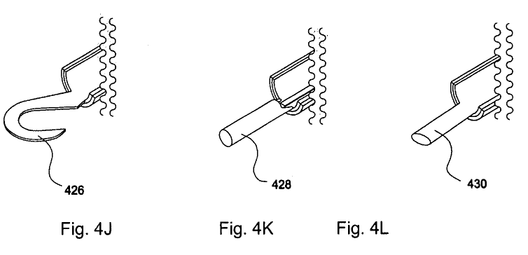

FIG. 4A and FIG. 4B show preferred embodiments of the conducting terminal 400, wherein the second end 404 of the conducting terminal 400 forms a ring terminal 408 or a multiple-stud ring terminal 410 that is disk-shaped and has a central opening.

FIG. 4C shows another embodiment of the conducting terminal 400, wherein the second end 404 of the conducting terminal 400 forms a serrated ring terminal 412 that is disk-shaped and has a central opening with serrations extending into the opening. FIG. 4D shows another preferred embodiment of the conducting terminal 400, wherein the second end 404 of the conducting terminal 400 forms a blade terminal 414 that is an elongated blade in shape. FIG. 4E shows another embodiment of the conducting terminal 400, wherein the second end 404 of the conducting terminal 400 forms a lipped blade terminal 416 that is an elongated blade in shape and has a bent portion formed at a distal end thereof. FIG. 4F, FIG. 4G, FIG. 4H show other preferred embodiments of the conducting terminal 400, wherein the second end 404 of the conducting terminal 400 forms Y-shaped fork terminal 418, spade terminal 420 or locking spade terminal 422 that is a blade in shape and has an opening formed at a front edge thereof. FIG. 4I shows another preferred embodiment of the conducting terminal 400, wherein the second end 404 of the conducting terminal 400 forms a flange terminal 424 that is Y-shaped and has at least one bent portion at a distal end thereof. FIG. 4J shows another preferred embodiment of the conducting terminal 400, wherein the second end 404 of the conducting terminal 400 forms a hook terminal 426 that is a hook in shape and has an inclined opening. FIG. 4K and FIG. 4L show other preferred embodiments of the conducting terminal 400, wherein the second end 404 of the conducting terminal 400 forms a round pin terminal 428 that is an elongated round pin in shape, or an oblate pin terminal 430 that is an elongated oblate pin in shape.

In another embodiment, the present invention further provides a method for fabricating a conducting terminal connector. The conducting terminal connector 200 is used to join a conducting terminal 400 and a conducting wire 208. The conducting wire 208 includes a conducting core 212 and an insulating cladding 210 enclosing the conducting core 212. The fabricating method includes:

Providing an insulating tube 202, the insulating tube is shrunken and deformed when heated to a temperature higher than a first temperature and having a melting point at a second temperature;

Providing a conducting terminal 400, the conducting terminal 400 including a first end 402 accommodated in the insulating tube 202, and a second end 404 opposite to the first end 402, the second end 404 being exposed outwardly, for connecting to an external conducting contact point, the first end 402 being bent to form a longitudinal elongation 406 with an opening facing upward;

Providing a soldering sleeve 300, placing the soldering sleeve 300 on the longitudinal elongation 406 of the conducing terminal 400, the soldering sleeve 300 having a melting point at a third temperature between the first temperature and the second temperature, the soldering sleeve 300 having an outer periphery with a corrugated surface 308 formed thereon, the soldering sleeve 300 allowing for insertion of the conducting core 212 with the insulating cladding 210 stripped off; and

Applying a heat source to an outer part 204 of the insulating tube 202 that corresponds to the soldering sleeve 300 to heat the insulating tube 202 to a temperature between the first temperature and the third temperature, an inner part 206 of the insulating tube 202 that corresponds to the soldering sleeve 300 shrinking due to heat and becoming lodged into corrugation gaps 302 of the soldering sleeve 300, thereby forming the conducting terminal connector 200.

In accordance with the aforementioned embodiment, the soldering sleeve 300 may be configured as shown in any one of FIGS. 3A, 3B, 3C, 3D and 3E.

In accordance with the aforementioned embodiment, the conducting terminal 400 may be configured as shown in any one of FIGS. 4A, 4B, 4C, 4D, 4E, 4F, 4G, 4H, 4I, 4J, 4K, and 4L.

It will be apparent to those skilled in the art that various modifications and variations can be made to the structure of the present invention without departing from the scope or spirit of the invention. For example, more than one conducting wires may insert into one end of the terminal connector so that the connector simultaneously joins more than two conducting wires. It is intended that the disclosure cover modifications and variations of this invention provided they fall within the scope of the following claims and their equivalents.

1. A conducting terminal connector configured for joining a conducting terminal and at least one conducting wire, each conducting wire comprising a conducting core and an insulating cladding enclosing the conducting core, the conducting terminal connector comprising:
an insulating tube shrunken and deformed when heated to a temperature higher than a first temperature and having a melting point at a second temperature;
a conducting terminal including a first end accommodated in the insulating tube, and a second end opposite to the first end, the second end being exposed outwardly for connecting to an external conducting contact point, the first end being bent to form a longitudinal elongation with an opening facing upward; and
a soldering sleeve placed on the longitudinal elongation of the conducing terminal, the soldering sleeve having a melting point at a third temperature between the first temperature and the second temperature, the soldering sleeve having an outer periphery with a corrugated surface formed thereon, the soldering sleeve allowing for insertion of the conducting core with the insulating cladding stripped off;
wherein when a heat source is applied to an outer part of the insulating tube that corresponds to the soldering sleeve to heat the insulating tube to a temperature between the first temperature and the third temperature, an inner part of the insulating tube that corresponds to the soldering sleeve is shrunken in order to lodge into corrugation gaps of the soldering sleeve, thereby forming the conducting terminal connector.

2. A conducting terminal connector configured for joining a conducting terminal and at least one conducting wire, each conducting wire comprising a conducting core and an insulating cladding enclosing the conducting core, the conducting terminal connector comprising:
an insulating tube shrunken and deformed when heated to a temperature higher than a first temperature and having a melting point at a second temperature;
a conducting terminal including a first end accommodated in the insulating tube, and a second end opposite to the first end, the second end being exposed outwardly for connecting to an external conducting contact point, the first end being bent to form a longitudinal elongation with an opening facing upward; and
a soldering sleeve placed on the longitudinal elongation of the conducing terminal, the soldering sleeve having a melting point at a third temperature between the first temperature and the second temperature, the soldering sleeve being formed by winding a solder wire so that its outer periphery has a corrugated surface, the soldering sleeve allowing for insertion of the conducting core with the insulating cladding stripped off;
wherein when a heat source is applied to an outer part of the insulating tube that corresponds to the soldering sleeve to heat the insulating tube to a temperature between the first temperature and the third temperature, an inner part of the insulating tube that corresponds to the soldering sleeve is shrunken in order to lodge into corrugation gaps of the soldering sleeve, thereby forming the conducting terminal connector.

3. The conducting terminal connector according to claim 1 wherein the
soldering sleeve further comprising an inner corrugated surface.

4. The conducting terminal connector according to claim 1, wherein the longitudinal elongation is semicircular or C-shaped.

5. The conducting terminal connector according to claim 1, wherein the corrugated surface of the soldering sleeve is wave-like or serrate.

6. The conducting terminal connector according to claim 1, wherein the material of the soldering sleeve is selected from the group consisting of tin, lead, nickel, gold, silver, copper, bismuth, and alloys of these metals.

7. The conducting terminal connector according to claim 1, wherein one end of the soldering sleeve further comprises an extension over said longitudinal elongation of the conducting terminal, said extension is provided with a radial enlargement for better insertion of said conducting core.

8. The conducting terminal connector according to claim 1, wherein the material of the conducting terminal is selected from the group consisting of brass, bronze, copper alloy, stainless steel, gold, karat gold and platinum.

9. A method for fabricating a conducting terminal connector, the conducting terminal connector configured to join a conducting terminal and a conducting wire, the conducting wire comprising a conducting core and an insulating cladding enclosing the conducting core, the fabricating method comprising:
providing an insulating tube, the insulating tube is shrunken and deformed when heated to a temperature higher than a first temperature and having a melting point at a second temperature;
providing a conducting terminal, the conducting terminal comprising a first end accommodated in the insulating tube, and a second end opposite to the first end, the second end being exposed outwardly, for connecting to an external conducting contact point, the first end being bent to form a longitudinal elongation with an opening facing upward;
providing a soldering sleeve, placing the soldering sleeve on the longitudinal elongation of the conducing terminal, the soldering sleeve having a melting point at a third temperature between the first temperature and the second temperature, the soldering sleeve having an outer periphery with a corrugated surface formed thereon, the soldering sleeve allowing for insertion of the conducting core with the insulating cladding stripped off; and
applying a heat source to an outer part of the insulating tube that corresponds to the soldering sleeve to heat the insulating tube to a temperature between the first temperature and the third temperature, an inner part of the insulating tube that corresponds to the soldering sleeve is shrunken in order to lodge into corrugation gaps of the soldering sleeve, thereby forming the conducting terminal connector.

10. A method for fabricating a conducting terminal connector, the conducting terminal connector configured to join a conducting terminal and a conducting wire, the conducting wire comprising a conducting core and an insulating cladding enclosing the conducting core, the fabricating method comprising:
providing an insulating tube, the insulating tube is shrunken and deformed when heated to a temperature higher than a first temperature and having a melting point at a second temperature;
providing a conducting terminal, the conducting terminal comprising a first end accommodated in the insulating tube, and a second end opposite to the first end, the second end being exposed outwardly, for connecting to an external conducting contact point, the first end being bent to form a longitudinal elongation with an opening facing upward;
providing a soldering sleeve, placing the soldering sleeve on the longitudinal elongation of the conducing terminal, the soldering sleeve having a melting point at a third temperature between the first temperature and the second temperature, the soldering sleeve being formed by winding a solder wire so that its outer periphery has a corrugated surface, the soldering sleeve allowing for insertion of the conducting core with the insulating cladding stripped off; and
applying a heat source to an outer part of the insulating tube that corresponds to the soldering sleeve to heat the insulating tube to a temperature between the first temperature and the third temperature, an inner part of the insulating tube that corresponds to the soldering sleeve is shrunken in order to lodge into corrugation gaps of the soldering sleeve, thereby forming the conducting terminal connector.

11. The method for fabricating a conducting terminal connector according to claim 10, wherein, the soldering sleeve further comprising an inner corrugated surface.

12. The method for fabricating a conducting terminal connector according to claim 10, wherein one end of the soldering sleeve further comprises an extension over said second end of the conducting terminal, said extension is provided with a radial enlargement for better insertion of said conducting core.

13-24. (canceled)
